(19) United States
(12) Patent Application Publication
(10) Pub. No.: US 2024/0388676 A1
(43) Pub. Date: Nov. 21, 2024

(54) Image Subject Individuation and Monitoring

(71) Applicant: SeeChange Technologies Limited, Manchester (GB)

(72) Inventors: Andrew Jonathan Robert Lee-Smith, Ormskirk, Lancashire (GB); Michael Andrew Pallister, Beaconsfield, Buckinghamshire (GB); Tigran Soghbatyan, Lódz (PL)

(21) Appl. No.: 18/694,063

(22) PCT Filed: Sep. 7, 2022
(86) PCT No.: PCT/GB2022/052275

§ 371 Date: Mar. 21, 2024

(30) Foreign Application Priority Data
Sep. 22, 2021 (GB) 21 13513.2

(51) Int. Cl. H04N 7/18; G06T 7/80; G06V 10/75; G06V 20/52; H04N 23/90

(52) U.S. Cl. CPC H04N 7/181; G06T 7/80; G06V 10/751; G06V 20/52; H04N 23/90; G06T 2207/30232

(57) ABSTRACT

A method for operating a space monitoring apparatus networked with a first camera positioned to capture position data and image data suitable for individuation of a subject and a second camera positioned to capture position data of a subject, the cameras sharing a portion of a field of view. The method includes extracting individuating data and position data of a subject from an image captured by the first camera, extracting second position data of a subject from an image captured by the second camera and matching the first and second position data. Responsive to a match indicating that the first and second subject are an identical entity, creating a tracking reference tagged with the individuating data, storing the tagged reference in a data store for reuse, and signalling the reference to a tracking logic component to coordinate continuity of tracking of the identical entity with the cameras.

The present technology is directed to an apparatus and technique to enable a space monitoring system to achieve continuity of individuation of an imaged subject in spite of periods of temporary occultation.

Cameras and other image capture devices, in conjunction with image recognition technologies are becoming widespread for many purposes. Subjects such as ships in port facilities (or narrow straits or ship canals), vehicles on roads and in carparks, people in stores and airports, and wild or domestic animals are frequently monitored using cameras and image recognition technologies. Typical reasons for such monitoring include traffic and crowd control or planning, statistics gathering for facilities planning, and animal protection and husbandry.

In developing robust and useful systems for these purposes, a number of difficulties must be addressed. First, the areas in which camera and image recognition technologies are deployed are typically large, with the result that multiple cameras may need to be deployed to capture images of an entire area. Second, the subjects that are to be monitored are normally in motion, and the motion may be erratic as to the paths taken and as to the speed at which the subject is moving. Third, the subjects may present variable aspects to the cameras covering an area—that is, one camera may capture a top-down view, a front view, or a side or rear view of the subject, while another camera may capture only an entirely different aspect, which makes continuity or persistence of identification of a subject, or “individuation” difficult. Fourth, the areas are also frequently complex—that is, the areas to be monitored may contain obscuring features, such as supporting columns, furniture, partitions, trees, buildings and the like, which again may require deployment of multiple cameras, and this also makes continuity of monitoring of a subject difficult. For an identification of an individual subject to attain a level of persistence in these circumstances presents a serious obstacle to achieving effective monitoring of a space in order to extract useful data for control and planning purposes.

In a first approach to addressing the difficulties of achieving continuity of individuation of an imaged subject in spite of periods of temporary occultation, there is provided a method of operating a space monitoring apparatus in networked communication with a set of cameras including at least a first camera positioned to capture position data and image data suitable for individuation of a subject and a second camera positioned to capture position data of a subject, said first and said second cameras sharing at least a portion of a field of view, comprising extracting first individuating data and first position data of a first subject from an image captured by said first camera; extracting second position data of a second subject from an image captured by said second camera; matching said first and said second position data; responsive to a positive match from said position matcher indicating that said first and said second subject are an identical entity, creating a tracking reference tagged with said first individuating data; storing said tracking reference tagged with said first individuating data in a data store for reuse; and signalling said tracking reference to a tracking logic component to coordinate continuity of tracking of said identical entity with said set of cameras.

The tracking logic component may provide physical control of operation of cameras or other devices to maintain a continuous surveillance of a subject over time. This control may, for example, comprise activation of the camera, control of tracking motions, and the like. As would be understood by one of skill in the art, the cameras described may not be limited to devices operating in the visual part of the spectrum. The data store may comprise any of the storage means that are or become available in the technology.

In a second approach, there is provided a method of calibrating a space monitoring apparatus to maintain continuity of captured position data of a subject, comprising: capturing simultaneous position data of a training subject in a shared field of view from first and second camera data; creating a data point associating position data from said first camera data with position data from said second camera data to create a map of said shared field of view; and storing said data point for use after training to determine that a first subject in an image from said first camera and a second subject in an image from said second camera are an identical entity.

In a third approach, there is provided a method of calibrating a space monitoring apparatus to match captured position data of a subject, wherein a second camera has a field of view of a shared area that has a perspective that is incompatible with a field of view of a first camera, and further comprising: applying a perspective transform to said second camera field of view of said shared area; and creating an adjusted map of said shared field of view to accommodate said perspective transform.

In a hardware implementation, there may be provided an electronic apparatus comprising electronic logic elements operable to implement the methods of the present technology. In another approach, the method may be realised in the form of a computer program operable when loaded into a computer system and executed thereon, to cause a computer system to perform the steps of the method of the present technology. In another approach, the computer program is stored on a non-transitory computer-readable storage medium.

Implementations of the disclosed technology will now be described, by way of example only, with reference to the accompanying drawings, in which:

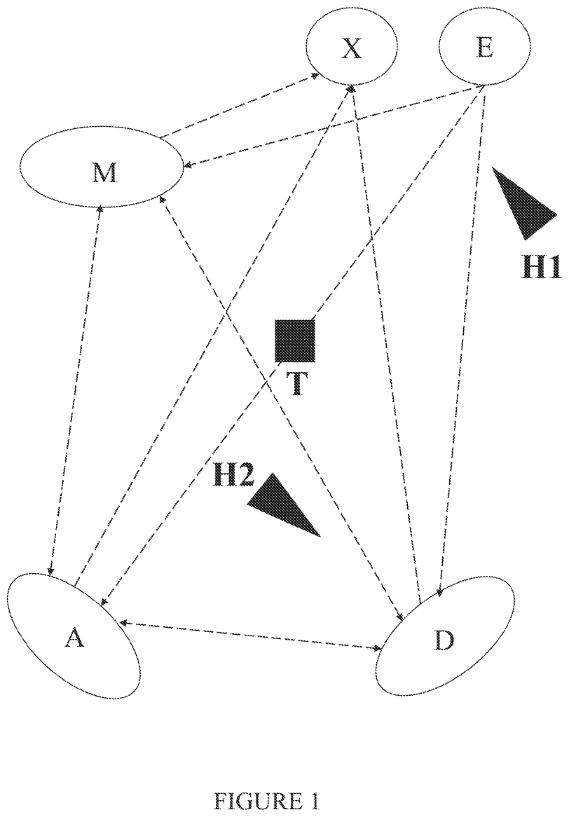

FIG. 1 shows a top-down view of a space monitored by multiple cameras and having several points of interest, which may be, for example, entrances, exits and destination points;

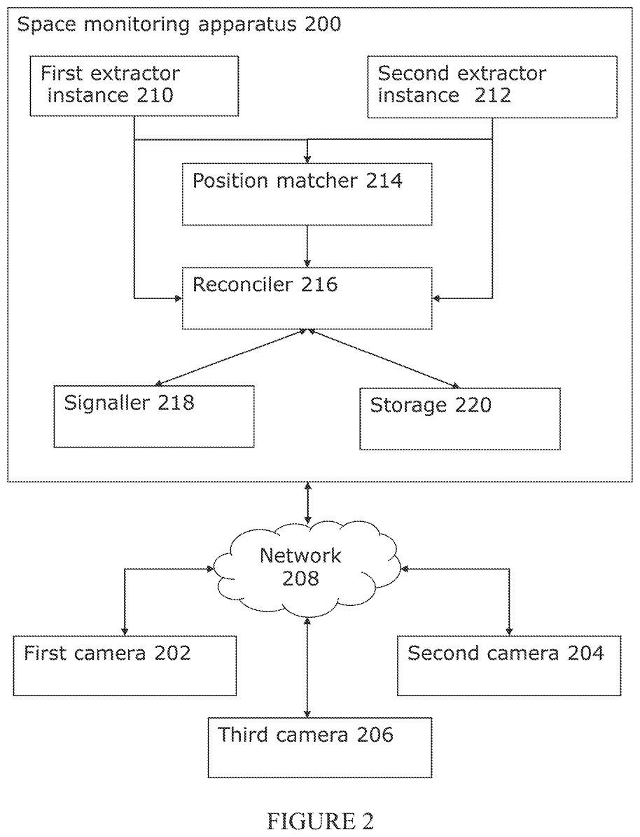

FIG. 2 shows a block diagram of a simplified example of a space monitoring apparatus according to an instance of the present technology;

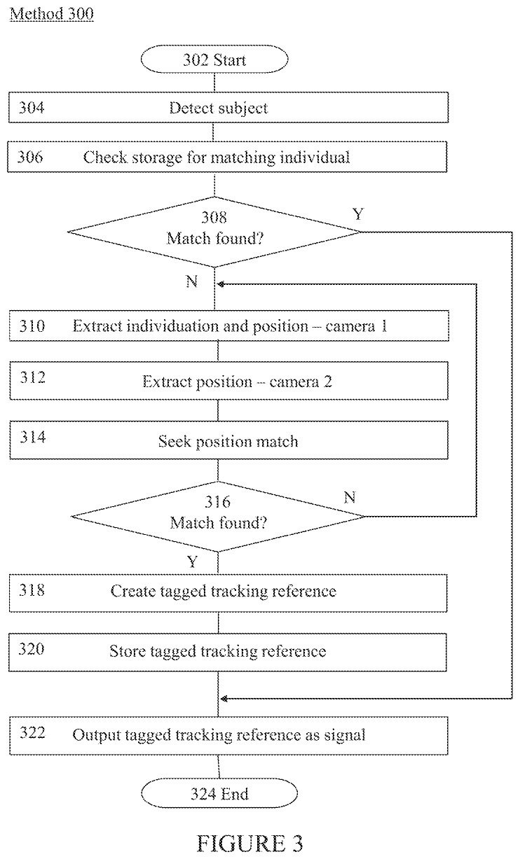

FIG. 3 shows a simplified method of operation of a space monitoring apparatus according to an instance of the present technology; and

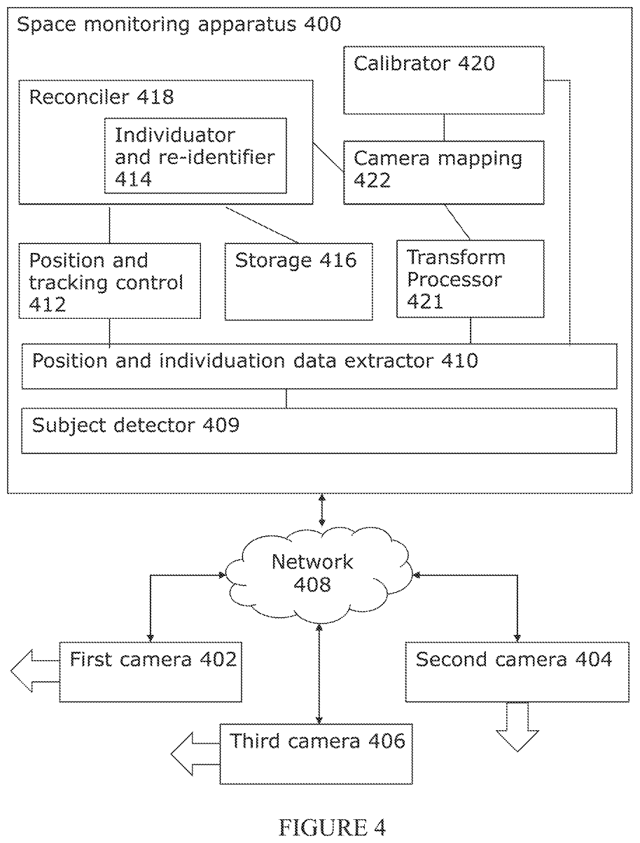

FIG. 4 shows a block diagram of a simplified example of a space monitoring apparatus according to a further instance of the present technology.

As described above, there are many different scenarios where it may be necessary or desirable to follow a subject, such as a vehicle or person, in a reasonably large area. If an area is large or complex—for example, having obscured or hidden places—full and continuous coverage may be difficult to achieve. The size or layout of the area involved may dictate that a single camera cannot see enough of the space to be able to see the subject at all times (or for a sufficient amount of time) to serve the purpose of the monitoring. For example, a single horizontal-view camera may show the distinguishing features (individuation) of a subject—for example, a subject's face and body—but may lose the subject's position if the subject wanders out of the camera's field of view, or if the subject is occluded by an intervening object. Equally disadvantageously, a single vertical-view camera may be able to pinpoint and follow the position of a subject, but will probably not show sufficient distinguishing features to make individuation possible. In such a case, a reappearance of a temporarily out-of-view subject can only be identified as a new subject—the subject cannot be re-identified as the same as a previously individuated subject.

The present technology addresses this and other issues by providing a method of “handing over” a subject being tracked from camera to camera using multiple cameras, and of calibrating pairs of cameras and enhancing the view of the cameras to maintain the track of the subject. The underlying technology that is used to accomplish these processes is that of a modelling system that comprises sets of models of the space to be monitored in relation to the fields of view of the various cameras, the various points of interest of the space, the identifying characteristics of subjects (for example, persons) that are to be monitored during their occupancy of the space, the characteristics of movement of the subjects in the space, and the like. From the various elements of this model, conclusions can be drawn about the various entities making up the monitored space and the subjects that from time to time occupy portions of the monitored space.

The operating environment of the present technology and of the technology in various implementations will now be described by way of example. As will be clear to one of ordinary skill in the art, the examples are much simplified, and in the real world, there will be multiple instances, variations and modifications of the various elements described, and those elements will therefore be understood by those of skill in the art as being equally operable in more complex environments. The simplified descriptions and drawing figures are given as examples only.

In FIG. 1, there is shown a top-down view of a space monitored by multiple cameras and having several points of interest, which may be, for example, entrances, exits and destination points.

In FIG. 1, points E and X represent entrance/exit points connecting the monitored space with the external world. Point M represents a point of interest wholly within the monitored space. Point A represents a way from the monitored space to a further space having a separate entrance and exit. Point D represents an entry and exit point to an enclosed space that can be accessed from the monitored space, but which has no other entrance or exit points. Square T represents a substantially vertically oriented camera arranged to provide a view looking downward onto the monitored space. Triangles H1 and H2 represent substantially horizontally oriented cameras arranged to provide views looking along in the directions indicated by the apexes of the triangles, thus giving substantially horizontal views of subjects respectively near entrance points E and X and the enclosed space entry and exit point D.

To provide monitoring of the space, a system is operable to analyse frames from the cameras and to extract data relating to subjects that enter the monitored space, traverse the monitored space, exit the monitored space and potentially re-enter the monitored space. Two forms of data are used in this process. First, what will be referred to herein as positional data—that is, data relating to positions and movements of the subjects in the monitored space. Second, what will be referred to herein as individuation data—that is, data that enables a model (such as a machine-learning model that is trained on training data and then executed on real data) to distinguish an individual entity (a person or thing) and to maintain a continuity, or persistence, of identification of that entity for the purpose of deriving useful data about the individuated entity's movements. As will be clear to one of skill in the art, the maintenance of continuity of identification of a subject enables the system to provide more useful monitoring data than would be the case if entities could not be shown to persist over temporary occultation (such as entering and then returning from the enclosed space at D).

As will be immediately clear to one of skill in the art, there is a need to calibrate the space monitoring system to maintain continuity of captured position data of a subject. This can be achieved by first capturing simultaneous position data of a training subject in a shared field of view from first and second camera data. This simultaneous capture is then used to create a data point associating position data from the first camera data with position data from the second camera data to create a map of the shared field of view. The data point is then stored for use after training to enable the model to determine that a first subject in an image from said first camera and a second subject in an image from said second camera are an identical entity.

Turning to FIG. 2, there is shown a generalised block diagram of the components of a space monitoring apparatus that is operable in an environment such as that shown in FIG. 1 to provide the required maintenance of continuity of identification of a subject over such temporary occultation.

In FIG. 2, space monitoring apparatus 200 is operable in electronic communication over network 208 with first camera 202, second camera 204 and third camera 206. In the present example, first camera 202 may be positioned to give a substantially horizontal view of a subject that permits extraction of individuating data that enables the space monitoring apparatus to distinguish the subject from other subjects in the field of view of the camera. If the subject is a person, this data may be, for example, a vector indicating hair colour, upper body clothing colour, lower body clothing colour and footwear colour. If the subject is a vehicle, the individuating data may comprise, for example, vehicle colour, class of vehicle (such as truck, car, motorcycle . . . ) and license plate or other registration mark. The view of the subject from the first camera 202 also permits extraction of position data. Second camera 204 and third camera 206, in the example, may be positioned to give substantially vertical, downward-looking views of a subject, from which position data may be extracted. One of skill in the art will recognise that this set of three cameras is intended as an example only, and that in a real-world scenario, any number of cameras may be used to implement the present technology.

Space monitoring apparatus 200 comprises extractor components operable to extract data from images supplied by cameras 202, 204, 206 over network 208. In the present example, there are two extractor instances—one of ordinary skill in the art will understand that this is intended to be exemplary only, and that plural instances may exist in any real-world system based on the present technology. A first extractor instance 210 is operable to extract individuation data for the subject from cameras that are capable of providing such data because of the orientation of their fields of view—for example, as described above, first camera 202—as well as position data for the subject. The process of extracting individuation data may first involve isolating the characteristic features of a subject with reference to the characteristics categorised within the model—the subject, such as a person, needs to be distinguished from the background image data (using any of the many well-known recognition techniques), to provide a bounding box indicating the contents of the bounding box as meeting the characteristic requirements to be identified as, for example, a person. Once the bounding box has been established, indicating that the subject is one of interest to the model, and thus one for which individuating characteristics as known to the model are relevant, a set of individuating characteristics of the subject as described above may be extracted by first extractor instance 210 using image recognition techniques that are well-known in the art. Typically, these activities are performed using a number of frames of image data to increase the probability that any analysis of features with reference to the model is accurate—as will be understood by those of skill in the art, these techniques are by their nature probabilistic, rather than mathematically exact. First extractor instance 210 also establishes a bounding box indicating the contents of the bounding box as meeting the characteristic requirements to be identified as, for example, a person and then extracts positional data for the subject.

Second extractor instance 212 is operable to analyse data received, in this example, from second camera 204 in order to establish a bounding box indicating the contents of the bounding box (the crop) as meeting the model's characteristic requirements to be identified as, for example, a person. Second extractor instance 212 is then operable to extract position data for the subject. The same limitations apply to second extractor instance 212 as apply to first extractor instance 210—100% accuracy of analysis is neither achievable nor necessary, but reasonable accuracy can be achieved by the use of the appropriate techniques over a number of frames of image data.

Position matcher 214 examines the position data from first extractor instance and second extractor instance to assess whether there is a match, such that it can be deduced that the two crops most probably show the same individual entity, as it is infeasible for two different entities to occupy the same space indicated by the mapping of the area of the field of view shared by the two cameras. If such a match exists, indicating that the model has successfully identified an entity, reconciler 216 is operable to identify or re-identify the individuated entity. That is, reconciler 216 first checks the set of individuating characteristics of the subject as provided by first extractor instance 210 against the sets of individuating characteristics of already-known entities stored in storage 220.

If there is a match, reconciler 216 signals the associated already-known unique identifier of that entity to a tracking logic component that identifies the entity to the apparatus, firmware or software responsible for monitoring data from at least the second camera. Signaller 218 may also pass the identification to further tracking logic components associated with further cameras, for example, third camera 206. In this way, after an individual entity has been out of range, occulted or otherwise not seen by any camera, it is still possible to associate the same identifier with it, thereby achieving continuity or persistence of individuation.

If there is no match with an already-known individual entity, the reconciler 216 is operable to associate the extracted individuation data (as a set of characteristics arranged, for example, as a vector) with a newly generated unique identifier of that entity, which can then be signalled by signaller 218 to a tracking logic component that, for example, identifies the entity to the apparatus, firmware or software responsible for monitoring data from at least the second camera. Signaller 218 may pass the identification to further tracking logic components associated with further cameras, for example, third camera 206. Reconciler 216 is further operable to pass the extracted individuation data and associated unique identifier to storage 220 to be stored for reuse as required.

The method of operation of the space monitoring apparatus or system will be more clearly understood with reference to the flow diagram in FIG. 3. The process 300 begins at Start 302, and at 304, a subject is detected by cameras arranged as described above. At 306, a check is performed to determine whether the subject is already known as an individuated entity in the system. The check is performed by querying the storage 220 shown in FIG. 2 to seek a match of the individuating characteristics that would enable an already existing unique identifier to be used for the re-identified entity. If a match is found at 308, the process moves to 322, at which a tagged output (that is, the unique identifier and data defining the associated individuating characteristics) is signalled as described above with reference to FIG. 2. This enables the tracking of the individuated entity to be continued as if no break in continuity existed. The process then completes at End 324. As will be clear to one of ordinary skill in the art, the process from Start 302 to End 324 represents a single iteration and the process may be repeated any number of times.

If no match is found at 308, at 310 the individuating data and position data for a detected subject are extracted from a first camera's input data frames. Simultaneously or near simultaneously, position data for a detected subject is extracted at 312 from a second camera's input data frames. At 314, the system seeks to match the position data extracted from the two sets of data frames, thereby seeking to identify situations where subjects detected by the first and second cameras occupy the same space simultaneously and must therefore represent a single individual entity that can be given a unique identifier. If a position match is not found at 316, the process returns to 310 and repeats until a position match is detected at 316.

If a position match is found at 316, indicating that subjects detected by the first and second cameras occupy the same space simultaneously and must therefore represent a single individual entity, a tagged tracking reference is created at 318. The tagged tracking reference created at 318 comprises a unique identifier of the individual entity and data defining the associated individuating characteristics. The tagged tracking reference is stored at 320 for potential future reuse, if a newly detected subject is matched by the model with the stored individuating characteristics of the existing individual entity. The tagged tracking reference is also output at 322 as a signal to a tracking logic component that, for example, identifies the individual entity to the apparatus, firmware or software responsible for monitoring data from at least the second camera. The tagged tracking reference may also be output at 322 as a signal to further tracking logic components associated with further cameras. The process completes at End 324. As will be clear to one of ordinary skill in the art, the process from Start 302 to End 324 represents a single iteration and the process may be repeated any number of times.

The technology described may, as described, be applied in numerous use cases in the fields of crowd and traffic management, facilities planning, animal protection and husbandry, and shipping, to cite a few examples. In one use case, using the simplified FIG. 1 as an example, there is an open area of a store having an entrance E, an exit X, a way into the main store A, an open-access counter M, and a separate concession area D. The main store A and separate concession area D lie outside any of the area camera coverage. The pathways from and to the various points E, X, A, M and D are represented, as described above, by dotted lines with directional flow arrowheads. Tringles H1 and H2 represent substantially horizontal view cameras and square T represents a substantially vertical downward-view camera. Cameras H1 and H2, being substantially horizontally oriented, are capable of capturing positional data of the subject when it is in their respective fields of view and also individuating data—examples of individuating data in this use case where the subject is a human may comprise upper body clothing colour, lower-body clothing colour, hair colour, show colour, or other distinguishing features. Camera T, being substantially vertically oriented, is less well adapted to capture distinguishing features, but is well adapted to capture positional data. For the purposes of the present use case, camera H1 is positioned to capture position and individuation data of those entering through E—thus individuating those subjects entering the area of interest from outside the whole store and concession area. Camera H2 is positioned to capture position and individuation data of those entering the area of interest from the separate concession area D.

In an illustrative use case, the main store has two entrances—one of the entrances (not shown in FIG. 1) has main store signage above the door, and the other (shown as E in FIG. 1) has concession store signage relating to concession area D. In reality they both lead into the main store, but the concession signed entrance has the concession area D store close to the main entrance E, and there are other concessions in the area such as a travel money exchange booth, shown as open-access counter M in FIG. 1.

The stated need for the operators of the main store (who also grant concessions) is to determine whether people are entering through the entrance E, visiting the concession area store D, and then leaving through the respective exit X without visiting the main store via the way in at A. Similarly, there may be a need to determine whether people have visited the travel money booth at open-access counter M and, if so, whether they have also visited the main store via the way in at A.

It is possible, though not optimal, to track people by having a single camera point at a space and use object detection to locate people in the frame and having an individuation model (also sometimes called a re-identification model) that generates a vector representing the cropped image of the person. The system can then compare the similarity of vectors between two crops of the person from different frames to determine if it is the same person. This approach can work in some constrained environments, but it is subject to some challenges. For example, the model may struggle to match two crops of the same person if they are from different angles (e.g. a view from behind the person as opposed to a view from the front). Also, the model needs to have an image of the person from a reasonably horizontal angle to work reliably. However, in meeting the constraint of having a horizontal view of the scene to see the person from a suitable angle, the set-up is subject to occlusions when people move behind and in front of each other, or behind furniture or other objects in the scene. The size of the area that a single camera can see is also limited. To address the issue of occlusions, having a camera mounted reasonably high up and pointing substantially straight down removes most of the occlusion problems. However, this does not meet the need to see the person from a substantially horizontal point of view, as individuating or re-identifying a person from a top-down camera works poorly.

In order to maximize the benefits of a top-down camera, get a view of the person from a substantially horizontal aspect, and to get a view of the person from a similar aspect to match the respective images, the present technology provides a system of multiple cameras operable to monitor a scene in combination with a mechanism to hand over an individual's identifying characteristics between cameras (typically, from top down view to top down view, top down view to substantially horizontal view, or substantially horizontal view to top down view). Handing on the characteristics from a substantially horizontal view to another substantially horizontal camera view is also possible. As will be clear to one of ordinary skill in the art, the concept of handing on characteristics from camera to camera in this context in fact refers to the handing on of the characteristics from one component of apparatus, firmware or software that manages the camera image data to another such component—the cameras themselves do not handle the transfer of data.

In an example configuration (with reference to the example shown in FIG. 1), there is provided an installation comprising three cameras. There is a single top-down camera paired with two substantially horizontally oriented cameras. The substantially horizontal cameras would get a front-on view of people as they enter through the store entrance E or exit from the concession area D. However, when they enter the concession area D, the people have their backs towards the camera view. This means that if someone enters the monitored area at E and then goes into concession area D, the different views cannot be relied on to reliably identify the person as being the same person who was seen entering the monitored area at E. When the person subsequently leaves the concession area D, the relevant camera is likely to have a front-on view similar to the one captured when the person entered the monitored area at E, and so the chance of recognizing them between entering the monitored area at E and exiting the concession area D into the monitored area is high.

There are also scenarios where there are two completely discrete areas that need to be monitored for the same people. For example, we might also want to know if a person has visited another concession in a different part of the store. For example, there may a café at the other entrance to the main store described above, and it is possible to provide a separate cluster of cameras doing similar detections and to use the unique identifier and characteristics from the original set of cameras to determine whether the same person visits both areas.

The top-down camera can see people everywhere in this area but does not see the people substantially horizontally, which is a better angle for effective recognition. Instead, the system must rely on a substantially horizontal camera to do the recognizing of the individual and to determine, in a handover area that is clearly visible to both cameras, that the person visible in each camera is one and the same person. This allows the unique identifier and characteristics of the person generated by the substantially horizontal camera to be handed over to the top-down camera. The top-down camera works at a sufficiently high frame rate to be able to track the person from frame to frame just by the proximity of the person between the two frames, so the top-down camera has no need of its own recognition algorithm.

In order to hand over the unique identifier and characteristics of a person between cameras, the following mechanism may be used. First, an area where the handover should happen is selected. This needs to be an area where both cameras can see reasonably clearly. In order to visualize the area across both cameras, in one example, some markers are placed on the floor to outline the area, typically a rectangle.

Because of the camera position of the substantially horizontal camera, the rectangle area typically appears as a distorted shape instead of a rectangle. A perspective realignment tool may then be used to transform the image data representing the camera view of the scene to adjust the shape of the area to be a rectangle. This process consists of determining a transformation matrix that transforms any points from the substantially horizontal view to be a top-down view, by outlining the rectangular shape as it appears in a substantially horizontal view. This transformation of the view distorts the objects in the scene including the people but corrects the mapping of the rectangle of interest, so in this example the operation of subject detection is performed on the original image data.

The top-down camera view of the rectangle is closer to a rectangle but depending on the camera lens and the position of the rectangle in the scene it might not appear as an exact rectangle. It may be distorted due to the barrel distortion of lens or the perspective distortion. Dependent on this, the system may use a transform to make the shape a rectangle, or it may simply crop the view. When the substantially horizontal camera view is corrected, the image of the person is distorted so that they look different between the views, but the shadow of the person on the ground in transformed view can still be seen to match closely.

Thus there is a need to calibrate the space monitoring system to match captured position data of a subject from a first and a second camera, in circumstances in which the second camera has a field of view of a shared area that has a perspective that is incompatible with a field of view of the first camera. As described above, this is achieved by applying a perspective transform to the second camera field of view of the shared area and creating an adjusted map of the shared field of view to accommodate the perspective transform.

As described above, it is desirable to have an effective and simple means to track subjects such as ships in port facilities (or narrow straits or ship canals), vehicles on roads and in carparks, people in stores and airports, and wild or domestic animals are frequently monitored using cameras and image recognition technologies. Typical reasons for such monitoring include traffic and crowd control or planning, statistics gathering for facilities planning, and animal protection and husbandry. In all these fields of endeavour, difficulties arise in providing continuity of identification of individual subjects where they are subject to occultation from time to time. The present technology addresses these issues by providing a way to store individuating characteristics with a unique identifier for a subject, so that, after a discontinuity of image coverage, the subject may be efficiently re-identified and thus the monitoring may continue as if there had never been a break.

Turning to FIG. 4, there is shown a block diagram of a simplified example of a space monitoring apparatus 400 according to a further instance of the present technology. Space monitoring apparatus 400 is arranged in electronic communication with cameras 402, 404, 406 over network 408. Space monitoring apparatus 400 comprises a subject detector 409 that is operable to detect a suitable subject according to characteristics set by a model and to activate position and individuation data extractor 410 to extract relevant data from images provided by the cameras 402, 404, 406. A position and tracking control component seeks and detects matches in position of subjects and passes the relevant position match information to reconciler 418, which comprises an individuator and re-identifier component 414 operable to either re-identify a subject that matches a previously-stored set of individuating characteristics in storage 416, or to create a new tagged tracking reference comprising a unique identifier and a set of individuating characteristics relating to the current subject. Reconciler 418 is operatively connected to camera mapping component 422 to enable individuator and re-identifier component 414 to refer to relevant image data during its processing. Any new tagged reference generated by reconciler 418 is stored in storage 416 for potential future reuse. Space monitoring apparatus 400 is further operable to emit signals comprising tagged tracking references to components that control the handling of camera image data. Camera mapping component 422 is in operative communication with a calibrator 420 that may draw upon data provided by position and individuation data extractor 410 during a training phase to calibrate camera points of view to provide the positional mapping capability that is needed to handle the data from the plurality of cameras according to the present technology. Camera mapping component 422 is also in operative communication with transform processor 421, which in some instances of the present technology is used to normalise views from cameras having disparate perspective or lens distortions to their fields of view, such that a normalising of the view is required to provide an effective means of mapping the monitored space.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments. In particular, in hardware embodiments, the term “component” may be interchangeable with the term “logic” and may refer to electronic logic structures that implement functions according to the described technology.

Furthermore, the present technique may take the form of a computer program product tangibly embodied in a non-transient computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C++, a scripting language, such as Python, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). Program code for carrying out operations of the present techniques may also use library functions from a machine-learning library, such as TensorFlow.

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a hardware descriptor language (such as Verilog™ or VHDL) which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1: A method of operating a space monitoring apparatus in networked communication with a set of cameras including at least a first camera positioned to capture position data and image data suitable for individuation of a subject and a second camera positioned to capture position data of a subject, said first and said second cameras sharing at least a portion of a field of view, comprising:
extracting first individuating data and first position data of a first subject from an image captured by said first camera;
extracting second position data of a second subject from an image captured by said second camera;
matching said first and said second position data;
responsive to a positive match from said position matcher indicating that said first and said second subject are an identical entity, creating a tracking reference tagged with said first individuating data;
storing said tracking reference tagged with said first individuating data in a data store for reuse; and
signalling said tracking reference to a tracking logic component to coordinate continuity of tracking of said identical entity with said set of cameras.

2: The method of claim 1, said extracting first individuating data further comprising operating a machine-learning model to determine characteristics of a subject in an image.

3: The method of claim 1, further comprising:
extracting second individuating data from a further image;
querying said data store for stored said first individuating data matching said second individuating data; and
in response to a positive match from said querying, indicating that said first and said second subject are an identical entity, reusing said tracking reference.

4: The method of claim 1, said signalling comprising signalling said tracking reference to a modelling logic component associated with third camera in said set of cameras to coordinate tracking of said identical entity in images captured by said third camera.

5: The method of claim 4, said coordinating tracking comprising replacing a new tracking reference generated for an image captured by said third camera with said tracking reference signalled to said modelling logic component.

6: The method of claim 1, further comprising positioning said first camera to capture a substantially horizontal view field.

7: The method of claim 1, further comprising positioning said second camera to capture a substantially vertical view field.

8: The method of claim 1, further comprising positioning said third camera to capture a further substantially vertical view field.

9: A method of calibrating a space monitoring apparatus to maintain continuity of captured position data of a subject, comprising:
capturing simultaneous position data of a training subject in a shared field of view from first and second camera data;
creating a data point associating position data from said first camera data with position data from said second camera data to create a map of said shared field of view; and
storing said data point for use after training to determine that a first subject in an image from said first camera and a second subject in an image from said second camera are an identical entity.

10: A method of calibrating a space monitoring apparatus to match captured position data of a subject, wherein a second camera has a field of view of a shared area that has a perspective that is incompatible with a field of view of a first camera, and further comprising:
applying a perspective transform to said second camera field of view of said shared area; and
creating an adjusted map of said shared field of view to accommodate said perspective transform.

11: The method according to claim 10, further comprising matching said adjusted map to a respective map of said field of view of said shared area according to said first camera.

12: A space monitoring apparatus operable in networked communication with a set of cameras including at least a first camera positioned to capture position data and image data suitable for individuation of a subject and a second camera positioned to capture position data of a subject, said first and said second cameras sharing at least a portion of a field of view, comprising electronic logic circuitry operable to perform the method according to claim 1.

13: A computer program comprising computer program code to, when loaded into a computer system and executed thereon, cause the computer system to perform all the steps of the method according to claim 1.

14: A space monitoring apparatus operable in networked communication with a set of cameras including at least a first camera positioned to capture position data and image data suitable for individuation of a subject and a second camera positioned to capture position data of a subject, said first and said second cameras sharing at least a portion of a field of view, comprising electronic logic circuitry operable to perform the method according to claim 9.

15: A space monitoring apparatus operable in networked communication with a set of cameras including at least a first camera positioned to capture position data and image data suitable for individuation of a subject and a second camera positioned to capture position data of a subject, said first and said second cameras sharing at least a portion of a field of view, comprising electronic logic circuitry operable to perform the method according to claim 10.

16: A computer program comprising computer program code to, when loaded into a computer system and executed thereon, cause the computer system to perform all the steps of the method according to claim 9.

17: A computer program comprising computer program code to, when loaded into a computer system and executed thereon, cause the computer system to perform all the steps of the method according to claim 10.
